(19) United States
(12) Patent Application Publication
(10) Pub. No.: US 2026/0210173 A1
(43) Pub. Date: Jul. 23, 2026

(54) Fastening Member

(71) Applicant: THE REAL GEORGIAN BAR COMPANY LIMITED, Preston (GB)

(72) Inventors: Philip Dewhurst, SR., Preston (GB); Philip Dewhurst, JR., Preston (GB)

(21) Appl. No.: 19/030,273

(22) Filed: Jan. 17, 2025

(51) Int. Cl. E06B 3/68; E06B 3/968

(52) U.S. Cl. CPC E06B 3/68; E06B 3/9681

(57) ABSTRACT

A fastening member for mounting a fenestration unit bar assembly to a fenestration unit. The fastening member includes a body and a mounting region. The mounting region includes two opposing clip members extending generally away from the body. The clip members are configured such that when a bar member is fitted to the fastening member the clip members are configured to flex to engage a complimentary portion of the exterior trim member to form a mechanical connection therebetween.

### FIELD

The present teachings relate to a fastening member for mounting a fenestration unit bar member. In addition, the present teachings relate to a kit of parts and to fenestration units incorporating such fastening members.

### BACKGROUND

A typical modern fenestration assembly comprises a sealed fenestration unit about the edge of which is provided a four-sided frame, either an outer frame in the case of a fixed unit, or of a casement in the case of a pivotable or slidable panel within an outer frame.

Some customers desire an effect on their windows or doors such as the appearance of a Georgian bar (divided lite) thereon. A Georgian bar or divided lite is a cross or trellis effect on the fenestration unit, supporting multiple smaller panels in a pane. For reasons of manufacturing complexity, it is undesirable to manufacture genuine Georgian or divided lite windows, especially for double or triple glazed units, but the appearance can be achieved by bars mounted to the surface of the fenestration unit. An example of how this may be achieved is shown in EP1552101B1 granted to the present applicant and may be referred to as a simulated divided lite (SDL).

A trend in the fenestration industry has been observed towards window frames with slim and/or flush rebates in some markets, which can improve sight lines though windows and create a minimalist “look”, and/or save cost. Further aluminium and hybrid (e.g., wood with aluminium cladding) windows are becoming more common in addition to uPVC, and have tighter tolerances around the rebate.

A problem arises in how to provide Georgian bars/SDLs that can match the look of these windows and be adaptable to different frame and bar materials.

The present teachings seek to overcome or at least mitigate the problems of the prior art.

### SUMMARY

A first aspect of the present teachings provides a fastening member for mounting a fenestration unit bar member to a fenestration unit, the fastening member comprising: a body and a mounting region; the mounting region comprising two opposing clip members extending substantially away from the body; the clip members being configured such that when a bar member is fitted to the fastening member the clip members are configured to flex to engage a complimentary portion of the exterior bar member to form a mechanical connection therebetween. The fastening member may be a sheet of material, and the clip members may be formed monolithically from the material of the member. The clip members may be pressed from the member, leaving a corresponding aperture in a plane of the body of the fastening member.

Advantageously this simplifies the manufacturing process and lowers cost compared to the prior art. It also allows for greater ease of installation and removal for replacing, repairing, or cleaning the exterior members. It also minimises the amount of material required to form the clip and simplifies the manufacturing process.

The mounting region may define a longitudinal axis, and the two clip members may be offset from each other along the longitudinal axis.

Advantageously, this distributes the contact between the fastening member and exterior bar member over a greater area, increasing the security of the exterior bar member.

The mounting region may define a longitudinal axis, and the two clip members may be offset from each other transverse to the longitudinal axis.

Advantageously, this enables the clip members to co-act and retain the exterior bar member securely, and also to be dimensioned to mount pre-existing bar assembles, as well as new ones enabled by the fastening members of the present teachings.

The two clip members may be configured to flex in a cantilevered way towards or away from each other.

By having two independent clip members that are not linked and are independently cantilevered, it is possible to incorporate a greater amount of flex into the structure to assist assembly of a bar thereto.

The mounting region may comprise three or more clip members.

Advantageously, this allows for a greater surface area of connection between the clip member and exterior bar member.

The sheet may have a thickness of 0.5mm or less.

The sheet may have a thickness of around 0.3mm.

This allows the overall thickness of the glazing bar to be minimised, so that it is able to match window frames with shallow rebates.

The clip members may extend from opposing edges of the aperture.

Advantageously, this allows for greater security between the fastening member and the exterior bar member.

The clip members may be shaped to provide an undercut section.

This facilitates the mechanical connection with the bar member.

The clip members may comprise a curved or angled guide surface remote from the body and the undercut.

This facilitates the flexing of the clip members to aid fitting of the bar member.

The fastening member may be manufactured from a metallic material.

The fastening member may be manufactured from stainless steel.

The use of metal, as opposed to plastics material allows a compact fastening member to be provided in a cost-effective way in a volume process, and yet has the required resilience that it can mount and mechanically hold bar assemblies formed from a number of different materials, which may not themselves be flexible or resilient.

The mounting region may be a first mounting region, and the fastening member may further comprise a separate second mounting region located remotely from the first mounting region.

Advantageously, this allows for the fastening member to mount a second independent bar member.

The body may be formed from substantially planar portions.

Advantageously, this enables a thin profile of the fastening member to be achieved and therefore a lower overall thickness of bar member.

The body may form a substantially U shape. The U shape may be fitted around a fenestration unit.

Advantageously, this allows the fastening member to be secured around the fenestration unit to better secure the external bar members, and also allow the bar members to be fitted on both sides of the fenestration unit.

The U shape may be formed by two creases. An internal angle of each crease may be between 75^{o} and 90^{o} in a relaxed state, optionally 80^{o} to 89^{o}.

Advantageously, this creates a closer frictional fit between the fastening member and fenestration unit which will aid in mounting and securing the member.

The body may have a planar rear portion for adhesion to a surface of a fenestration unit.

Advantageously, this removes the need for penetrative or invasive mounting techniques in the fenestration unit.

The body may have a planar front portion between the first and second mounting regions.

Advantageously, this means that an exterior bar member can cross the body of a fastening member, so that multiple exterior bar members can form a cruciform shape.

The planar front portion may form a gap between the first and second mounting regions of at least an equal length to one of the mounting regions.

Advantageously, this means that an exterior bar member can cross the body of a fastening member, so that multiple exterior bar members can form a cruciform shape.

A second aspect of the teaching provides a kit of parts comprising the fastening member according to the first teaching and a fenestration unit bar member to be mechanically connected thereto, in use.

A third aspect of the teaching provides a kit of a parts according to the second aspect of the teaching, wherein the fenestration unit bar member is substantially rigid, and the fastening member is configured to deform upon assembly of the fenestration unit bar member.

This allows the fastening member to be used with a wide variety of fenestration unit bar assemblies, in particular those made of wood or aluminium that are typically rigid, without addition features being provided to allow the bar assemblies to flex or deform themselves.

The fastening member and fenestration unit bar member may be configured to connect with a push fit connection.

Advantageously, this allows for the removal and or replacement of the exterior bar member.

A fourth aspect of the teaching provides a fenestration unit assembly for installing within an opening, the fenestration unit assembly comprising: a frame member; a fenestration unit positioned within a portion thereof the frame; a fastening member according to the first aspect of the teaching; and a fenestration unit bar member mechanically connected to the fastening member.

Each mounting region of a fastening unit according to any aspect of the teaching may provide more than 10N of retention when a fenestration unit bar member is attached to said fastening unit, optionally more than 15N.

The overall height of each clip member may be less than 5mm.

A fifth aspect of the present teachings provides a fastening member for mounting a fenestration unit bar member to a fenestration unit, the fastening member comprising:

a body and a mounting region; the mounting region comprising at least two opposing clip members extending substantially away from the body; the clip members being configured such that when a bar member is fitted to the fastening member the clip members are configured to flex to engage a complimentary portion of the bar member to form a mechanical connection therebetween, wherein the mounting region defines a longitudinal axis and the at least two clip members are offset along the longitudinal axis from each other.

### BRIEF DESCRIPTION OF DRAWINGS

Embodiments will now be described by way of example only with reference to the accompanying figures, in which:

FIG. 1 is a front view of a fenestration unit with bar members attached using fastening members of the present teachings;

FIG. 2 is an isometric view of a U shaped fastening member of the present teachings;

FIG. 3 is an end view of a part of a U-shaped fastening member of FIG. 2 alone on the plane z-z of FIG. 1;

FIG. 4A is a similar view to FIG. 3, but with an aluminium bar member shown attached to the fastening member in broken lines;

FIG. 4B is a similar view to FIG. 3, but with a low profile bar member shown attached to the fastening member in broken lines;

FIG. 5 is an isometric view of a bridging fastening member of the present teachings; and

FIG. 6 is an isometric view of an intermediate fastening member of the present teachings.

### DETAILED DESCRIPTION

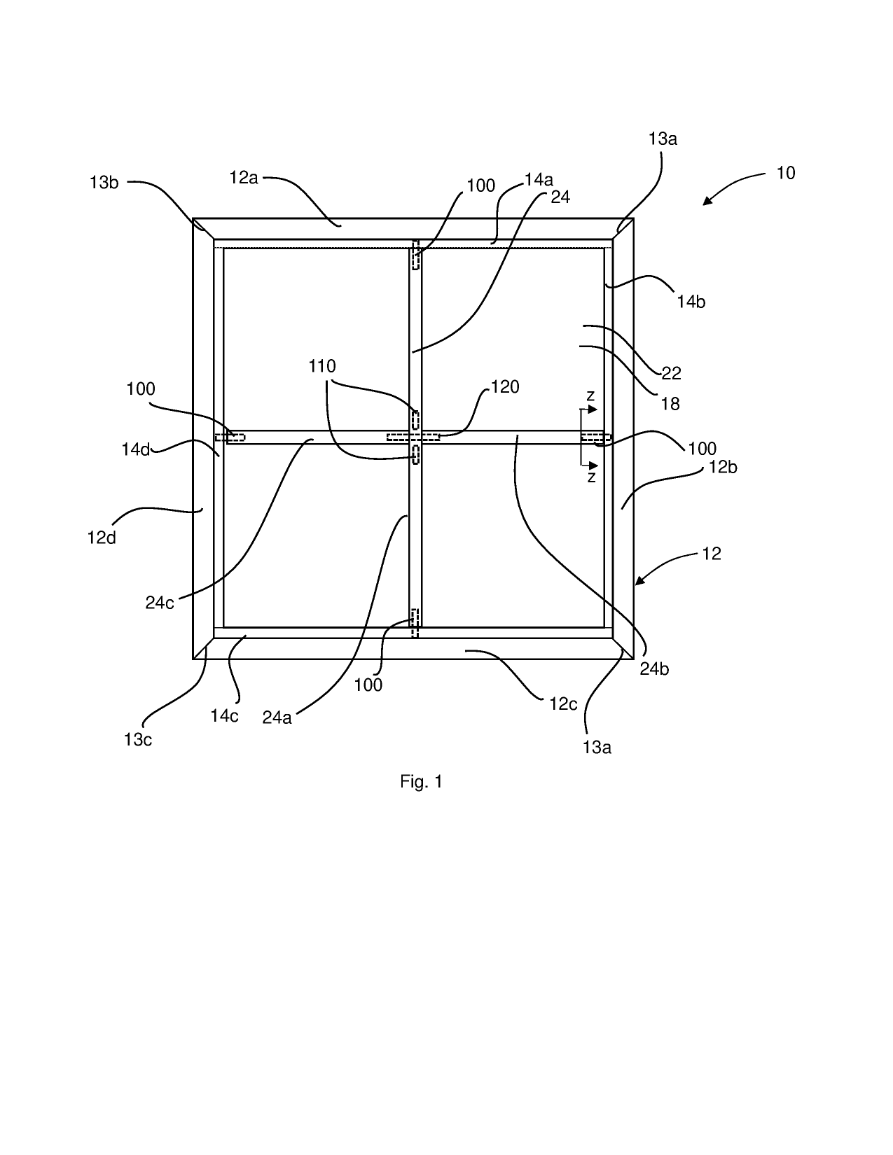

Referring firstly to FIG. 1, a fenestration unit of an embodiment of the present teachings is generally indicated at 10. The fenestration unit 10 has frame assembly 12 comprising frame members 12a-d and glazing beads 14a-d mounted thereto.

The fenestration unit 10 includes a frame assembly 12 made up of a plurality of frame members 12a-d. The fenestration unit 10 is suitable for a window, door or other type of fenestration, such as a vent or cladding panel. The frame assembly 12 receives and supports a pane or panel 18 such as a pane of glass, a double or triple glazed sealed unit, or a panel of wood, aluminium or other suitable material. It shall be appreciated that in the embodiment of FIG. 1, the panel 18 is a glazing unit and the fenestration unit is a window.

Fenestration units 10 of this type are typically used in exterior walls of domestic and commercial buildings. It is therefore necessary that the fenestration unit 10 meets requirements for thermal insulation, sealing against water ingress, draughts etc.

It shall be appreciated that the term ‘exterior’ refers to the area outside of the fenestration unit 10, and the term ‘interior’ refers to the area enclosed between the frame member 12d and the glazing unit 18. Therefore, for example, ‘exterior side’ refers to the side closest to the outside of the fenestration unit 10, and ‘interior side’ refers to the side closest to the area enclosed between the frame member 12d and the glazing unit 18.

It shall be appreciated that the bar member of the present teachings is suitable for used on an alternative frame assembly, for example a beadless frame assembly. In a beadless frame assembly, the frame members have U-shaped cross-sections and connectors are used to join adjacent frame members around the glazing unit.

In order to provide a desired aesthetic on the glazing unit 18, bar members 24 are secured over the interior 22 and exterior (not shown) faces of the glazing unit 18.

In the embodiment of FIG. 1, there is a first set of three bar member assemblies secured to the exterior face of the glazing unit 18, and a second set 24 of three bar members 24a, 24b, 24c secured to the interior face 22 of the glazing unit 18 in alignment with the first set.

The first and second sets of bar members 24 each include a member 24a dimensioned to extend between the first frame member 12a and the third frame member 12c. The bar member 24a is secured to a first fastening member 100 located in the first frame member 12a at a first end, and to a second fastening member 100 located in the third frame member 12c. Intermediate fastening members 110 are also provided to support the bar member 24a near its midpoint.

The bar members 24b, 24c are dimensioned to extend between the mounting assemblies 100 located in the second and fourth frame members 12b12d and a longitudinal midpoint of the bar member 24a. A bridging fastening member 120 is provided to secure the bar members 24b, 24c to each other behind the first bar member and optionally to the glazing unit 18 and/or the bar member 24a via adhesive tape (not shown). The fastening members 100, 110 and 120 are described in more detail below.

In alternative embodiments any number of bar assemblies may be provided depending on the aesthetic requirements of the fenestration unit. It shall be appreciated that although only one exposed face 22 of the glazing unit is illustrated in FIG. 1, the pattern of the assemblies is mirrored on the opposing exposed face 20 of the glazing unit 18.

In other embodiments four bar members may be mounted to each face, each extending half of the width/height of the glazing and meeting in the centre with an arrowhead mitre.

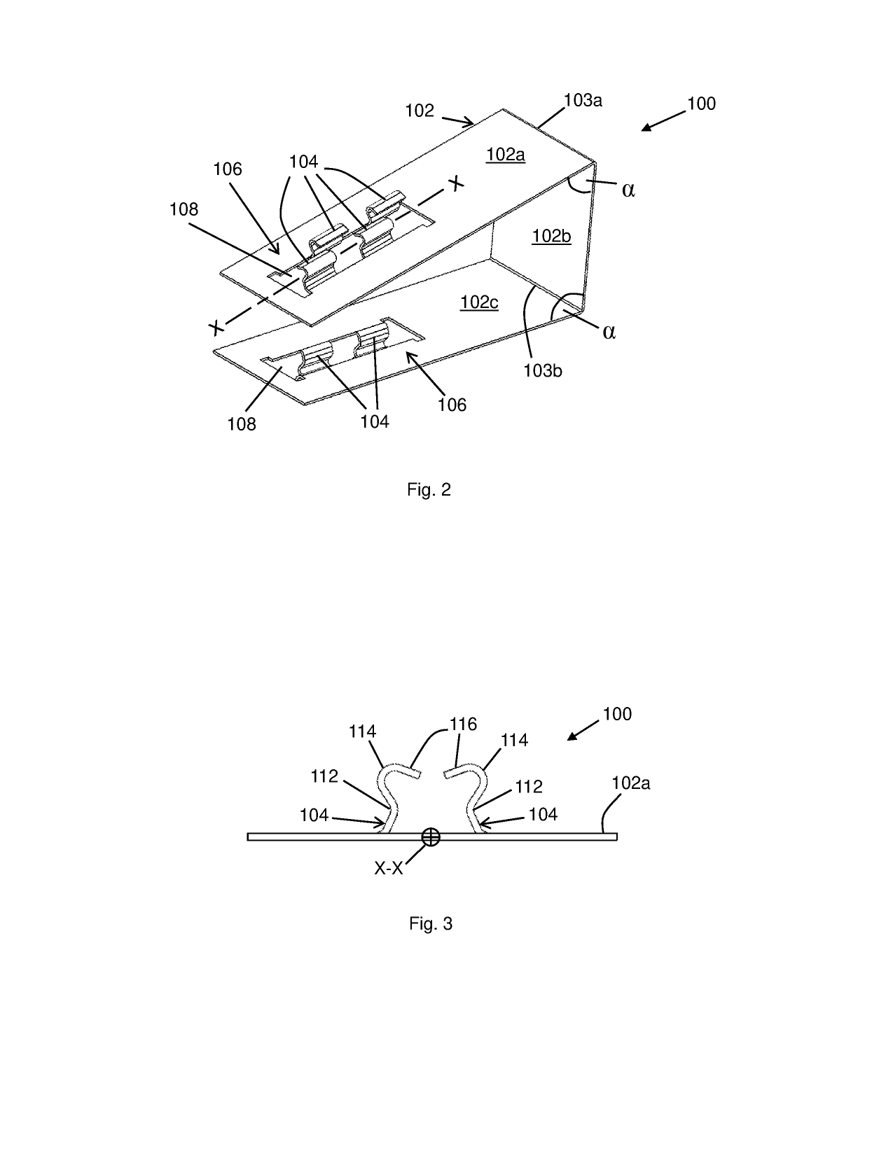

Referring to FIGS. 2, 3 and 4, the U-shaped fastening member 100 is described in more detail. The fastening member 100 comprises a body 102 formed of thin sheet material, in this embodiment 0.3mm thick stainless-steel sheet, for example 301N tempered stainless steel. The body is formed into three faces 102a, 102b, 102c delineated by edges 103a, 103b. The internal width of the second face 102b is substantially the same as the thickness of the glazing unit 18 so that the first and third faces 102a and 102c can overlie the exterior and interior faces of the glazing unit 18 in a face-contacting relationship. Since glazing units are typically provided in standard thicknesses, versions of the U-shaped member may be provided to match these thicknesses: for example, 25.4mm, 22.75mm and 19.55mm. in this embodiment the internal angle α of the edges 103a and 103b is less than 90°, e.g., around 84°. This provides a frictional engagement between the fastening member 100 and the glazing unit 18 which may be of assistance during assembly.

The first and third faces 102a and 102c are generally planar proximate the edges 103a and 103b such that when fitted in the frame they may extend past the bead 14a-d and rebate of the frame members 12a-d without unduly disturbing perimeter gaskets (not shown) thereof.

Mounting regions 106 are provided proximate the free ends of the faces 102a and 102c. These mounting regions 106 are substantially identical and only one will be described in detail.

The mounting region 106 comprises two pairs of opposing clip members 104 extending generally away from the body 102. The clip members 104 are shaped to engage a complimentary formation of the bar members 24a-c. In this embodiment the mounting region defines a longitudinal axis x-x and the pairs of 104 are offset from each other both longitudinally along and transverse to of the axis x-x. In other embodiments this may not be the case.

Each clip member 104 is cantilevered and formed into a shape flexing about axes parallel to axis x-x and to enable engagement with the bar members 24a-c. Specifically, the clip members 104 are formed as tongues monolithically with the body and are shaped with an undercut 112 proximate the body 102 and a guide surface 114 remote from the body 102 and the undercut. In this embodiment the clip members are each generally S or hook shaped with a curved transition from the undercut 112 to the guide surface. The opposing pairs of clip members 104 are mirror images of each about the axis x-x.

In this embodiment, each clip member 104 terminates with an inward curve 116 which has the benefit of helping with alignment of the bar members 24a-c onto the mounting regions 106 and to avoid presenting sharp edges to the assembler of the fenestration unit, but are not essential to the functioning of the fastening member 100 otherwise.

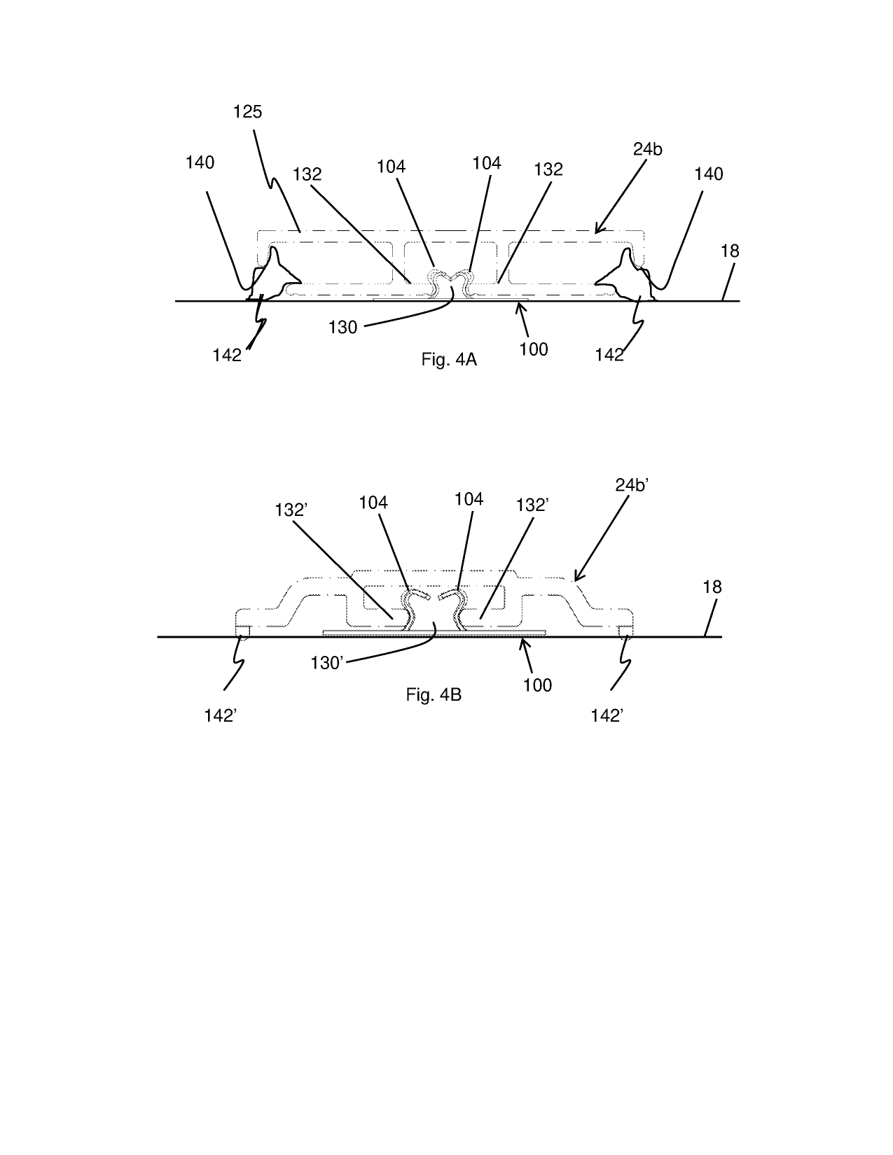

With reference to FIG. 4A, the engagement of the fastening member 100 with the corresponding bar member 24b can be seen. In this embodiment the bar member 24b comprises a body 125 of extruded aluminium having an elongate mouth 130 defined by inner walls 132 thereof. In addition, slots 140 are provided at lateral edges of the body into which resilient gaskets 142 are push-fitted.

The transverse width of the mouth 130 is such that when brought into contact with the opposing clip members 104, the ends of the walls 132 contact the guide surfaces 114 and cause the clip members to flex inwardly from the position shown in broken lines. Continued pushing of the bar member 24b towards the fastening member 100 allows the ends of the walls to enter the undercuts 112 and the clips 104 to relax outwardly to a degree. As a result, the opposing pairs of clips 104 co-act and hold the bar member 24b in place in a secure push-fit manner. The gaskets 142 bear against the glazing unit 18 to provide a neat finish and seal the underside of the bar 24b.

Using bar assemblies 24b of aluminium is increasingly popular, to enable the finish to be matched to windows whose frames are also aluminium. Aluminium bar assemblies 24b are heavier than comparable uPVC bars, however. Moreover, aluminium is not inherently resilient, so aluminium bar assemblies have relied on adhesive tape to be secured in place in the absence of suitable mechanical fastening members. This may present a safety risk if used on high-rise buildings, since if the tape fails and the bar falls, injuries or property damage could ensue. An advantage of the fastening members 100 of the present teachings is that they provide a secure connection to bar assemblies that does not rely on the resilience of the bar member and that is mechanically fixed to the fenestration unit itself, decreasing the risk of the bar assemblies 24b detaching and falling.

FIG. 4B demonstrates an embodiment of the fastening member with a low-profile bar member 24b’ attached. Similar parts are labelled with the same reference numbers as in FIG. 4A, but with the suffix ‘ . The low-profile bar member 24b’ extends approximately 5mm from the face of the glazing unit 18, as compared to known bar assemblies that are 10mm, or more, thick. This is advantageous, as in some markets there is trend towards windows with shallower rebates and low-profile bar assembles are required to aesthetically match these frames (i.e. not project out further than the frame itself). However, even if manufactured from uPVC, as is the case with the bar member 24b’, the smaller dimensions reduce the amount by which the bar member itself can flex. Thus, the fastening members of the present teachings are also advantageous in this application in view of their ability to flex, coupled with their low profile of less than 4mm, as described in more detail below.

The fastening member 100 of this embodiment is manufactured by cutting a rectangular piece of material from a strip thereof. The rectangle forms the body 102 of the fastening member and is approximately 120mm x 16mm (16mm being the width of the strip in this embodiment). Outlines of the clip members 104 also punched from the body simultaneously or in a separate step, along with an additional oblong of material being removed from each end of the mounting portion to form end apertures. At this stage the clips 104 are co-planar with the body and the opposing pairs interdigitate.

A tool then presses the clip members 104 outward from the body 102, and into shapes described above to form the mounting regions 106. The end apertures facilitate the accurate folding operation, and once folded a single aperture 108 is left at each mounting region 106in the space left by the clip members and removed oblongs of material.

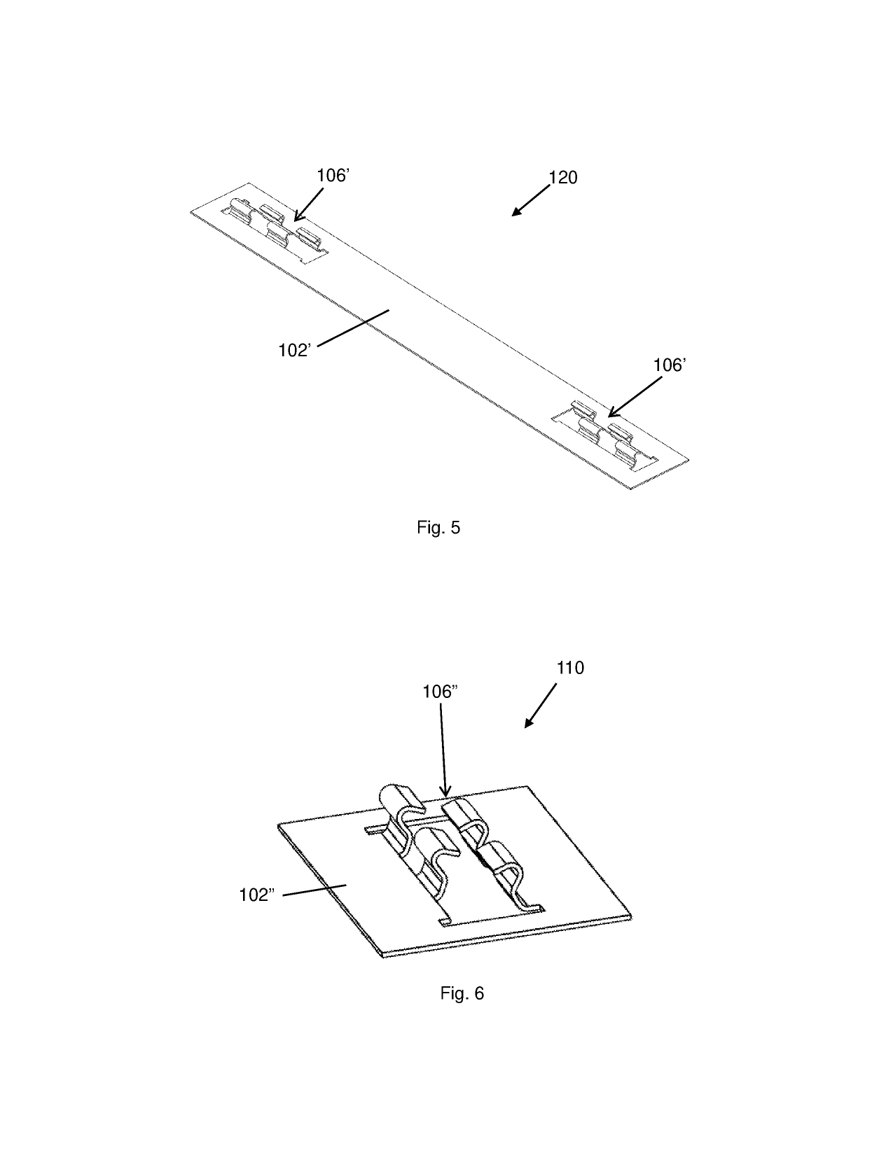

At this point the fastening member 100 resembles that of FIG. 5. The fastening member is then folded twice to form a U shape. Each of the folds have an internal angle of 90^{o} or less as described above.

A benefit of the use of sheet metal material and the forming process described above is that smaller clip members 104 can be formed compared to those of the prior art and tolerances can be tightly controlled. The overall height of each clip member 104 may be less than 5mm, in this embodiment around 3.35mm +/- 0.15mm and the overall width of opposing pairs of clips is less than 7mm, in this embodiment 4.85mm +/- 0.15mm. This, as well as the thin body (less than 0.5mm) enables slimmer bar profiles to be used compared to the prior art, and for the profiles to be securely held in place. Further, by building the flexibility/resilience of the mounting into the clip members means this is not needed on the bar assemblies themselves. This allows the bar assemblies to be made from a wider range of materials including those that are not inherently resilient, without requiring a more complex structures to combine, say, an exterior aluminium or wooden face with a resilient interior e.g., of uPVC.

In the embodiment of FIG. 5, a bridging fastening member 120 comprising a longer body 102’ in a single plane with a mounting region 106’ at each end of the body is shown. The mounting regions 106’ are substantially the same as each of the mounting regions of the U-shaped fastening member 106 and is made in the same way. Between the mounting regions 106’, the body 102’ is flat, allowing for a bar member 24a to pass transversely over the body. When further bar members 24b, 24c, are secured to the mounting region 106’ of the bridging fastening member, the bar members 24 will form a cruciform shape, as is desired in Georgian Bar/divided lite style designs. The bridging fastening member 120 may be provided with self-adhesive tape (not visible) on its rear side to be mounted to the glazing unit 18.

In the embodiment of FIG. 6, an intermediate fastening member 110 comprising a body 102” with one mounting region 106” is shown. The mounting region 106” is substantially the same as each of the mounting regions 106 of the U-shaped fastening member 100 and is made in the same way. The planar rear portion of the intermediate fastening member 110 allows for the member to be adhered to the face of the glazing unit 18, and therefore provide support for the bar members 24 at any point on the fenestration unit – for example where there may otherwise be a long unsupported run that may otherwise flex or sag. The intermediate fastening member 110 may be provided with self-adhesive tape (not visible) on its rear side to be mounted to the glazing unit 18.

in this embodiment, four U-shaped fastening members 100 are fitted around a glazing unit 18 prior to the fenestration unit being fitted into its frame assembly 12, and are adjusted to be central within the frame assembly before the beads 14a-d are fitted. The bridging fastening member 120 and intermediate fastening members 110 are then adhered to the faces of the fenestration unit with double sided tape in alignment with the U-shaped fastening members 100. The bar members 24 are then push fitted to the fastening members 100, 110, 120 in the configuration shown in FIG. 1 to secure them to the glazing unit 18. It is beneficial for each exterior bar member to be supported by a U-shaped fastening member 100, and at least one other fastening member 100, 110, 120. Depending upon the dimensions of the fenestration unit and rigidity of the bar members, additional intermediate fastening members 110 may be adhered to the glazing unit 18 as required.

To test the strength of the connection between the fastening members and the bar members, a test rig was constructed.

A 900mm bar member was secured to a fixture with its elongate mouth facing down. A hanging rig was constructed comprising four mounting regions and a basket to hold weights. This hanging rig was secured into the elongate mouth of the bar member and weights were introduced into the basket until the weight caused the rig to disconnect from the bar member. A total mass of 7kg was supported before separation. This is equivalent to a 68.7 Newton force, or 17.2 Newtons of force per mounting region. In use, this indicates that a force of 68.7N could be applied to a mounted exterior bar member (when mounted with four clip members) in a direction outward and adjacent to the plane of the clip members without separation occurring. Furthermore, the force that could be withstood by an exterior bar mounted in a different arrangement could be calculated by multiplying the number of clip members used by the force that can be withstood by a single clip member (17.2N). It will be appreciated that this force is significantly greater than that generated by the self-weight of the bar member, indicating that the bar member would be securely mounted in use.

Although the teachings have been described above with reference to one or more preferred embodiments, it will be appreciated that various changes or modifications may be made without departing from the scope as defined in the appended claims. For example:

A single cruciform fastening member with mounting portions at the end of each arm of the cross may be provided for the centre of the fenestration unit where the bar assemblies meet.

The number of clips provided for each mounting region may be increased or reduced.

The clip members could be larger or smaller to facilitate different shapes or sizes of exterior bar member.

The transverse spacing between clips increased or reduced, and the clips and corresponding bar member may be altered so that the pairs of clips flex away from each other upon insertion of a male member between them, before relaxing to engage and hold the bar member.

The shape of the clips and complementary formations of the bar member may be altered to provide a firmer retention, if required.

1. A fastening member for mounting a fenestration unit bar member to a fenestration unit, the fastening member comprising:
a body and a mounting region;
the mounting region comprising two opposing clip members extending substantially away from the body;
the clip members being configured such that when a bar member is fitted to the fastening member the clip members are configured to flex to engage a complimentary portion of the bar member to form a mechanical connection therebetween;
wherein the fastening member is a sheet of material, and the clip members are formed monolithically from the material of the member; and
wherein the clip members are pressed from the fastening member, leaving a corresponding aperture in a plane of the body of the fastening member.

2. The fastening member of claim 1, wherein the two clip members are configured to flex in a cantilevered way towards or away from each other.

3. The fastening member of claim 1, wherein the mounting region comprises three or more clip members.

4. The fastening member of claim 1, wherein the sheet has a thickness of 0.5mm or less, for example around 0.3mm.

5. The fastening member of claim 1, wherein the clip members extend from opposing edges of the aperture.

6. The fastening member of claim 1, wherein the clip members are shaped to provide an undercut section.

7. The fastening member of claim 6, wherein the clip members comprise a curved or angled guide surface remote from the body and the undercut.

8. The fastening member of claim 1, wherein the fastening member is manufactured from a metallic material, e.g. stainless steel.

9. The fastening member of claim 1, wherein the mounting region is a first mounting region and the fastening member further comprises a separate second mounting region located on the fastening member remotely from the first mounting region, optionally wherein the body has a planar front portion between the first and second mounting regions.

10. The fastening member of claim 9, wherein the planar front portion forms a gap between the first and second mounting regions of at least an equal length to one of the mounting regions.

11. The fastening member of claim 1, wherein the body is formed from substantially planar portions.

12. The fastening member of claim 1, wherein the body forms a substantially U shape, wherein the U shape can be fitted around a fenestration unit, optionally wherein the U shape is formed by two creases, optionally wherein an internal angle of each crease is between 75⁰ and 90⁰, for example between 80⁰ and 86⁰.

13. The fastening member of claim 1, wherein the body has a planar rear portion for adhesion to a surface of a fenestration unit.

14. A kit of parts comprising:
a fastening member for mounting a fenestration unit bar member to a fenestration unit, the fastening member comprising:
a body and a mounting region;
the mounting region comprising two opposing clip members extending substantially away from the body;
the clip members being configured such that when a bar member is fitted to the fastening member the clip members are configured to flex to engage a complimentary portion of the bar member to form a mechanical connection therebetween;
wherein the fastening member is a sheet of material, and the clip members are formed monolithically from the material of the member; and
wherein the clip members are pressed from the fastening member, leaving a corresponding aperture in a plane of the body of the fastening member, and
a fenestration unit bar member to be mechanically connected to the fastening member, in use.

15. The kit of parts of claim 14, wherein the fenestration unit bar member is substantially rigid, and the fastening member is configured to deform upon assembly of the fenestration unit bar member.

16. The kit of parts of claim 14, wherein the fastening member and fenestration unit bar member are configured to connect with a push fit connection.

17. A fastening member for mounting a fenestration unit bar member to a fenestration unit, the fastening member comprising:
a body and a mounting region;
the mounting region comprising at least two opposing clip members extending substantially away from the body; the clip members being configured such that when a bar member is fitted to the fastening member the clip members are configured to flex to engage a complimentary portion of the bar member to form a mechanical connection therebetween, wherein the mounting region defines a longitudinal axis and the at least two clip members are offset along the longitudinal axis from each other.

18. The fastening member of claim 18, wherein the mounting region defines a longitudinal axis and the at least two clip members are offset transverse to the longitudinal axis from each other.

19. The fastening member of claim 17, wherein the at least two clip members are configured to flex in a cantilevered way towards or away from each other.

20. The fastening member of claim 17, wherein the mounting region is a first mounting region and the fastening member further comprises a separate second mounting region located on the fastening member remotely from the first mounting region, optionally wherein the body has a planar front portion between the first and second mounting regions.
.
